(19) United States
(12) Patent Application Publication
(10) Pub. No.: US 2009/0265596 A1
(43) Pub. Date: Oct. 22, 2009

(54) SEMICONDUCTOR DEVICES, INTEGRATED CIRCUIT PACKAGES AND TESTING METHODS THEREOF

(75) Inventors: Hong-Ching Chen, Kao-Hsiung Hsien (TW); Yuan-Chin Liu, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/107,166

(22) Filed: Apr. 22, 2008

(51) Int. Cl. G06F 11/25

(52) U.S. Cl. 714/729; 714/E11.155

(57) ABSTRACT

An integrated circuit package comprising a semiconductor device and pins is provided. The semiconductor device comprises first and second scan chains, each having an input port and an output port. The semiconductor device further comprises at least two first pads, at least two second pads, and a connecting device. The at least two first pads are coupled to the input port of the first scan chain and the output port of the second scan chain, respectively. The at least two second pads are coupled to the output port of the first scan chain and the input port of the second scan chain, respectively. The connecting device is coupled between the first and the second chains, and is capable of controlling electrical connection between the input port of the second scan chain and the output port of the first scan chain. When the connecting device is disabled, the input port of the second scan chain is electrically disconnected from the output port of the first scan chain. The first pads are electrically connected to the pins and the second pads are not electrically connected to any pins of the integrated circuit package.

### BACKGROUND OF THE INVENTION

1. Field of the Invention

The invention relates to electronic integrated circuit testing, and in particular to circuits and methods for testing integrated circuits in a wafer level and a package level.

2. Description of the Related Art

Testing associated with fabrication of integrated circuit (IC) packages conventionally comprises chip-probe (CP) and final testing (FT). FIG. 12 illustrates a flow for manufacturing an IC package from a blank wafer. A blank wafer undergoes foundry processes, such as lithography, diffusion, etching, deposition and others. An array of dies with patterns, electronic devices, and electric connections is formed on a wafer after the foundry processes. Thereafter, CP test, also known as a wafer-level test, is introduced, using a probe card to provide die test signals through input or input/output pads of the die, and to monitor test results through output or input/output pads of the dies. Dies passing the CP test are typically packaged by electrically connecting the pads on the die to the package by means of bond wires, solder wires or other contact structures. After packaging, each IC package is contacted with a test socket to undergo FT test, or a package-level test, such that fault-free IC packages can be confirmed and marketed.

Each test stage has its unique and essential role in view of cost and reliability. While guaranteeing functional dies, CP testing further conserves package cost for bad dies, analysis of which also informs issues occurring during foundry processes. Packages that pass FT testing guarantee an IC package good for sale. Failure analysis of a bad package in final test, in view of a CP test, can reveal problems introduced solely by packaging.

As integrated circuit designs continue to increase in both complexity and density, circuits using Design-For-Test (DFT) techniques can improve testability and quality of the final product, integrated circuit package. Test methodologies can also provide high-quality, low cost test solutions.

A conventional design methodology includes initial design of an integrated circuit using a software design tool, simulating the overall functionality of the design or individual circuits within the design, and then generating test vectors for testing the overall function of the design. The test vectors are typically generated by an automated software tool (e.g., an Automatic Test Pattern Generator or “ATPG”) that provides a particular degree of fault coverage or fault simulation for the circuitry in the IC product. These test vectors are then typically provided in a computer readable file to Automatic Testing Equipment (ATE) or testers. The ATE is used in a manufacturing environment to test the die during CP or FT test.

In CP and final tests, scan chains are conventional means of accommodating test vectors for reducing the pad/pin count. A scan chain is defined as a linking series of logic cells tested by sequentially shifting data elements of a test vector into an input edge logic cell and, after testing of the logic cells is triggered and test results are latched in the logic cells, shifting the test results through the series to an output edge logic cell for observation. Scan chains are well-known in the art and examples can be found in several U.S. patents, such as U.S. Pat. Nos. 5,675,589 and 6,738,939, herein incorporated by reference in their entirety. A scan chain conventionally requires one input pin/pad as an entry port connected to the input edge logic cell and one output pin/pad as an exit port connected to the output edge logic cell. CP and FT tests usually share the same test patterns with the same test vectors. In this configuration, the cost of IC testing, TestCost, can be calculated by the formula:

$$\begin{matrix}TestCost = \# Pattern * Chain\_Length * ( {UC}_{CP} * {T}_{CP} + {UC}_{FT} * {T}_{FT} ) \\ = \# Pattern * \frac{\# DFF}{\# Scan\_Pin / 2} * ( {UC}_{CP} * {T}_{CP} + {UC}_{FT} * {T}_{FT} )\end{matrix} \qquad ( 1 )$$

where #Pattern refers to the pattern count, the number of groups of test vectors used during testing; Chain_Length to the length of a scan chain, which is equal to the count of D flip-flops in a scan chain; #DFF to the count of the D flip-flops in all scan chains of the tested die; #Scan_Pin to the pin count of input/output pins used for all scan chains; UC_{CP} and UC_{FT} to test costs per time unit for CP and final tests, respectively; and T_{CP} and T_{FT} to clock periods for CP and final tests, respectively. Basically, in the right of the formula (1), UC_{CP}*T_{CP} represents the testing cost per clock during CP test and UC_{FT}*T_{FT} the test cost per clock during FT test. Thus, “#Pattern*Chain_Length” in the formula represents the total clocks required for CP or FT test. Chain_Length also represents to the length of a test vector, each element of which requires a corresponding D flip-flop for registration. The #Scan_Pin is divided by 2 since each scan chain usually needs two pads/pins as entry and exit ports respectively. A given circuit function generally requires a certain number of D flip-flops and a certain number of test patterns such that the multiplication of #DFF and #Pattern are two constants. Thus, with increased scan chains under test at a time, the number of #Scan_Pin increases and the test costs are reduced.

However, the ratio of the count of all the D flip-flops to the pad count for scan chains increases, due to the relative-reduction in size of the integrated circuits compared to the size of the pads and the size of the pins. The size reduction allows more logic cells or circuits on a single die, without a corresponding increase in the maximum number of pad/pins that can fit on a die/package. Fewer pads or pins remain for testing a given amount of circuitry and thus fewer entry and exit ports for testing, increasing the ratio of #DFF to #Scan_Pin and, thus, the value of TestCost according to the above formula.

### BRIEF SUMMARY OF THE INVENTION

Embodiments of the invention provide an integrated circuit package comprising a semiconductor device and pins. The semiconductor device comprises first and second scan chains, each having an input port and an output port. The semiconductor device further comprises at least two first pads, at least two second pads, and a connecting device. The at least two first pads are coupled to the input port of the first scan chain and the output port of the second scan chain, respectively. The at least two second pads are coupled to the output port of the first scan chain and the input port of the second scan chain, respectively. The connecting device is coupled between the first and the second chains, and capable of controlling electrical connection between the input port of the second scan chain and the output port of the first scan chain. When the connecting device is disabled, the input port of the second scan chain is electrically disconnected from the output port of the first scan chain. The first pads are electrically connected to the pins and the second pads are not electrically connected to any pins.

Embodiments of the invention provide a method of testing circuitry. A semiconductor device is provided, comprising first and second scan chains, at least two first pads, and at least two second pads. The first and second scan chains test an integrated circuit inside the semiconductor device, each of the first and second scan chains having a input port and a output port. The at least two first pads are coupled to the input port of the first scan chain and the output port of the second scan chain, respectively. The at least two second pads are coupled to the output port of the first scan chain and the input port of the second scan chain. First and second test vectors are input in parallel to the first and second scan chains, respectively, during a wafer level test while the input port of the second scan chain is electrically disconnected from the output port of the first scan chain. The semiconductor device is packaged to electrically connect the first pads to pins of a socket and not electrically connect the second pads to any pins of the socket. The output port of the first scan chain and the input port of the second scan chain are electrically connected to join the first and second scan chains into a single scan chain. Third test vectors are input through the pins of the socket to the single scan chain.

Embodiments of the invention further provide a semiconductor device with a testing configuration. The semiconductor device comprises scan chains, I/O circuits, and a test result compressor. Each scan chain has a input port and a output port. The I/O circuits, each having a first pad, are configured to send to the input ports of the scan chains test vectors in one condition and to receive from the output ports of the scan chains test results in another condition. The test result compressor is coupled to the output ports of the scan chains, compressing the test results to output corresponding compressed results through a result pad.

Embodiments of the invention further provide an integrated circuit having a structure of scan testing. The integrated circuit comprises an input pad and an output pad, scan chains, a parallel circuit and a serial circuit. Based on a shift clock, scan chains receive test vectors and output test results. The parallel circuit parallelizes input data from the input pad to accordingly provide the test vectors to the scan chains. The serial circuit serializes the test results to output test data to the output pad. The parallel circuit and serial circuit operate based on a test vector clock having a frequency higher than the shift clock.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 illustrates a die, a semiconductor device, according to an embodiment of the invention;

FIG. 2 illustrates the die of FIG. 1 under a CP test;

FIG. 3 illustrates an integrated circuit package with the die of FIG. 1 under a FT test;

FIG. 4 shows a die with a core-limit design;

FIG. 5 shows a die with a pad-limit design;

FIG. 6 is a flowchart demonstrating a method of testing circuitry according to embodiments of the invention;

FIG. 7 illustrates a die with a testing configuration according to embodiments of the invention;

FIG. 8 illustrates the die of FIG. 7 during a CP test;

FIG. 9 illustrates the die of FIG. 7 during a FT test;

FIG. 10A shows I/O circuits IO₁-IOₙ used as entry ports and MSB pad 704 used as an exit port;

FIG. 10B shows I/O circuits IO₁-IOₙ used as both entry ports and exit ports, one at a time;

FIG. 11 illustrates an integrated circuit having a structure of scan testing; and

FIG. 12 illustrates the flow for manufacturing an IC package from a blank wafer.

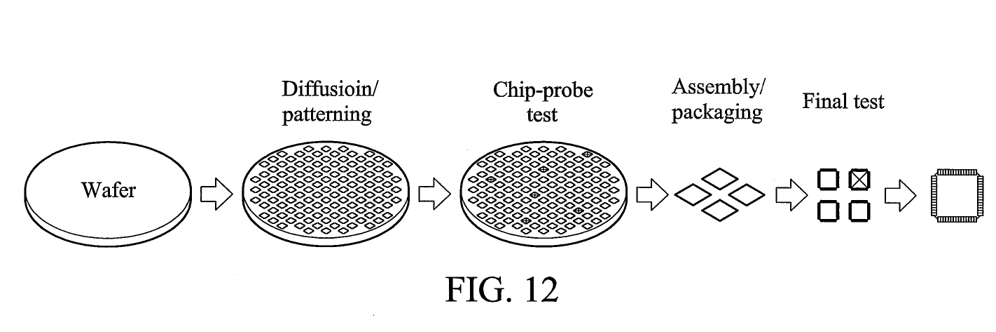

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

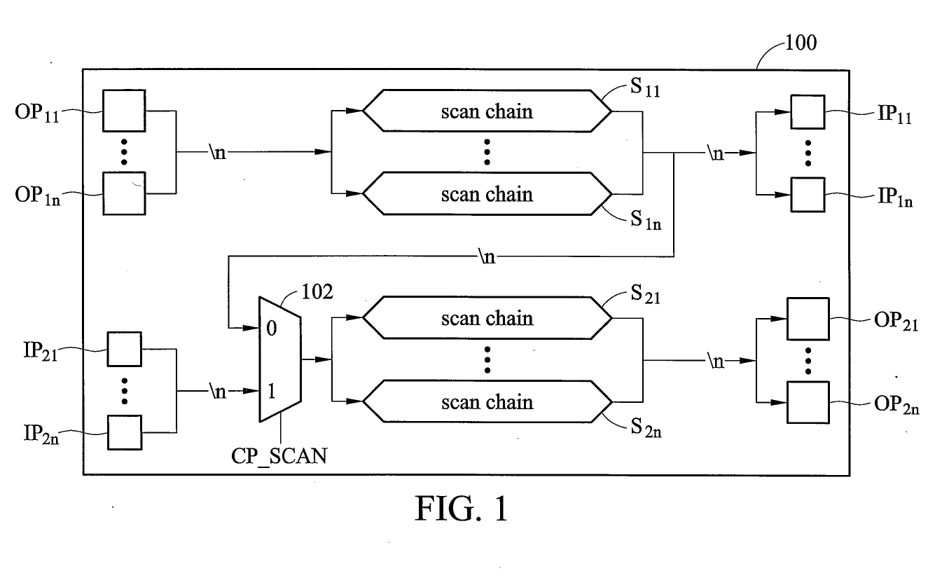

FIG. 1 illustrates a die, a semiconductor device, according to an embodiment of the invention. Die 100 comprises scan chains S₁₁˜S₁ₙ and S₂₁˜S₂ₙ, a multiplexer 102, and pads OP₁₁˜OP₁ₙ, IP₁₁˜IP₁ₙ, OP₂₁˜OP₂ₙ, and IP₂₁˜IP₂ₙ. As shown in FIG. 1, pads OP₁₁˜OP₁ₙ are respectively coupled to the left ports of scan chains S₁₁˜S₁ₙ, pads IP₁₁˜IP₁ₙ are respectively coupled to the right ports of scan chains S₁₁˜S₁ₙ, and pads OP₂₁˜OP₂ₙ are respectively coupled to the right ports of scan chains S₂₁˜S₂ₙ. As detailed, pads OP₁₁˜OP₁ₙ, IP₁₁˜IP₁ₙ, OP₂₁˜OP₂ₙ, and IP₂₁˜IP₂ₙ may be all of the same size, or pads OP₁₁˜OP₁ₙ and OP₂₁˜OP₂ₙ may be larger than that of pads IP₁₁˜IP₁ₙ and IP₂₁˜IP₂ₙ. Multiplexer 102 acts as a connecting device to couple the left ports of scan chains S₂₁˜S₂ₙ to either Pads IP₂₁˜IP₂ₙ or the right ports of scan chains S₁₁˜S₁ₙ depending upon the assertion or de-assertion of signal CP_SCAN.

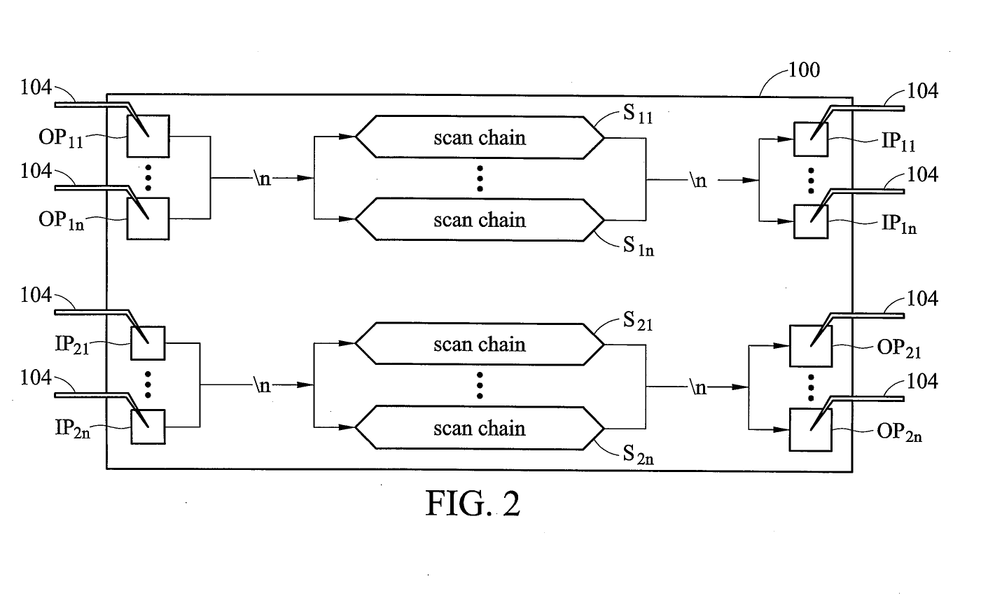

FIG. 2 illustrates die 100 of FIG. 1 under a CP test when signal CP_SCAN is asserted to allow multiplexer 102 to electrically disconnect the left ports of scan chains S₂₁-S₂ₙ from the right ports of scan chains S₁₁˜S₁ₙ. Therefore, signals conveyed or shifted by scan chains S₁₁˜S₁ₙ cannot go through scan chains S₂₁˜S₂ₙ, and vice versa. Probes of a probe card contact pads OP₁₁˜OP₁ₙ, IP₁₁˜IP₁ₙ, OP₂₁˜OP₂ₙ and IP₂₁˜IP₂ₙ, providing test vectors to scan chains S₁₁˜S₁ₙ and S₂₁˜S₂ₙ and receiving test results therefrom. Even though FIG. 2 shows that test vectors are input from the left ports of scan chains S₁₁˜S₁ₙ, S₂₁˜S₂ₙ and the test results are received from the right ports thereof, and the invention is not limited thereto. It can be understood by a person with ordinary skill in the art that the right ports of scan chains S₁₁˜S₁ₙ and S₂₁˜S₂ₙ may be input ports and the left ports thereof may be output ports. In other words, test vectors or results can be shifted from left to right or from right to left.

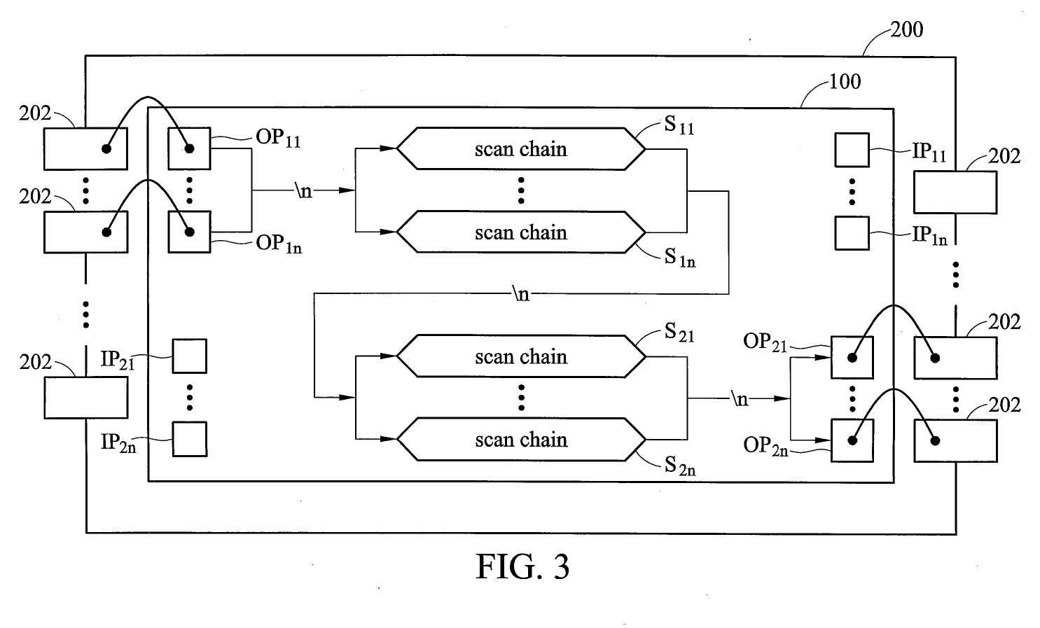

FIG. 3 illustrates an integrated circuit package 200 with die 100 of FIG. 1 under a FT test when signal CP_SCAN is de-asserted to allow multiplexer 102 to electrically connect the left ports of scan chains S₂₁˜S₂ₙ to the right ports of scan chains S₁₁˜S₁ₙ. Accordingly, every two scan chains, such as S₁₁ and S₂₁, S₁₂ and S₂₂, and the like, join to become a single scan chain. FIG. 3 also shows that after die 100 is packaged, pads OP₁₁˜OP₁ₙ and OP₂₁˜OP₂ₙ are electrically connected to pins 202 by way of integrated circuit package 200. On the other hand, bonding wires, pads IP₁₁˜IP₁ₙ, and IP₂₁˜IP₂ₙ are not connected to any pins. One pad is hereinafter defined as an out-bond pad if it is electrically connected to a pin of a resulting integrated circuit package, and as an inner pad if it is not. For example in FIG. 3, pads OP₁₁˜OP₁ₙ, and OP₂₁˜OP₂ₙ are out-bond pads, and pads IP₁₁˜IP₁ₙ, and IP₂₁˜IP₂ₙ are inner pads. During a FT test, test vectors are input from some pins and out-bond pads at left, shifted first to scan chains S₁₁˜S₁ₙ and then to scan chains S₂₁˜S₂ₙ. After corresponding results are latched in scan chains S₁₁˜S₁ₙ and S₂₁˜S₂ₙ, these test results are shifted out from out-bond pads and pins at right for verification in a tester. As mentioned, the shift direction is from left to right as indicated by the embodiment of FIG. 3, but it may be from right to left in another embodiment.

Formula (2) follows, equivalent to formula (1).

TestCost=#Pattern*(Chain_Length_{CP}*UC_{CP}*T_{CP}+Chain_Length_{FT}*UC_{FT}*T_{FT}) (2)

where Chain_Length_{CP} and Chain_Length_{FT} are lengths of the scan chains under CP and FT tests, respectively. Given that scan chains S₁₁˜S₁ₙ and S₂₁˜S₂ₙ are of the same length, L, Chain_Length_{FT} is 2L and Chain_Length_{CP} is only L. In comparison with a fixed length of 2L under both CP and FT tests, the scan chain length of die 100 is 2L in FIG. 3 under a FT test and is only L in FIG. 2 under a CP test. This implies that for each test pattern during a CP test for die 100 of FIG. 1 spends half the clock number of a FT test, reducing the CP testing cost. The reduction of the clock number for testing die 100 during a CP test is due to the incorporation of inner pads, as increasing the pad number shortens a scan chain length.

An inner pad can be a pad without any bonding wires thereon in a resulting package. In another aspect, a pad having a bonding wire thereon to specifically connect to an embedded memory can be an inner pad in FIG. 1 for inputting test vectors or outputting test results during a CP test. The embedded memory can be DRAM or flash ROM, for example. An inner pad in FIG. 1 can be one of package-option pads, which are sets of pads respectively prepared for different packages. For example, integrated circuit package 200 can be a BGA (ball grid array) package and pads OP₁₁˜OP₁ₙ and OP₂₁˜OP₂ₙ are pads specially designed to use for a BGA package while pads IP₁₁˜IP₁ₙ and IP₂₁˜IP₂ₙ are designed only for a LQFP (low profile quad flat package) package.

With increased pins or pads incorporated for input or output during testing, resulting scan chains become shorter and the testing costs lower, making it preferable to incorporate as many pads as possible for scan chains. Even though a scan chain shifts in or out only digital data, a pad coupled to the scan chain need not be confined to a digital pad transporting only digital data. One of pads OP₁₁˜OP₁ₙ and OP₂₁˜OP₂ₙ can be an analog pad defined in the integrated circuit product specification to transport only analog signal, but can be configured to transport digital signal from a scan chain during testing. In other words, one of pads OP₁₁˜OP₁ₙ and OP₂₁˜OP₂ₙ can belong to an analog input or output circuit capable of being configured to transport digital signal when die 100 is under CP or FT tests. The analog input or output circuit can be switched to a full-swing mode during testing for transporting digital data, acting as an entry or exit port for a scan chain.

The addition of pads IP₁₁˜IP₁ₙ and IP₂₁˜IP₂ₙ, inner pads, might not increase the die cost of die 100 in FIG. 1. As mentioned, an inner pad can have no bonding wire thereon and act only a landing place for a probe on a probe card. An inner pad, having no bonding wire thereon, can be smaller than an out-bond pad, which generally requires minimum landing area and structure strength for accommodating and sustaining a bonding wire thereon.

Moreover, the ESD protection level during probing is generally looser and less critical than that for sustaining the ESD stress from an external pin. Thus, an inner pad need not be associated with a high-level ESD protection circuit, which generally occupies a considerably-large silicon area and is costly. Furthermore, unlike an out-bond pad, which, in order to be bonded to a package pin, is generally limited to location in a peripheral area surrounding a core area of a die, an inner pad can be freely located in the peripheral area or the core area. In other words, smaller, simpler inner pads can be placed anywhere on a die that is originally unoccupied. If a die is a core-limit design, which means the peripheral area of the die cannot be fully filled by out-bond pads, inner pads can be inserted or placed into the peripheral area without increasing the overall size of the die.

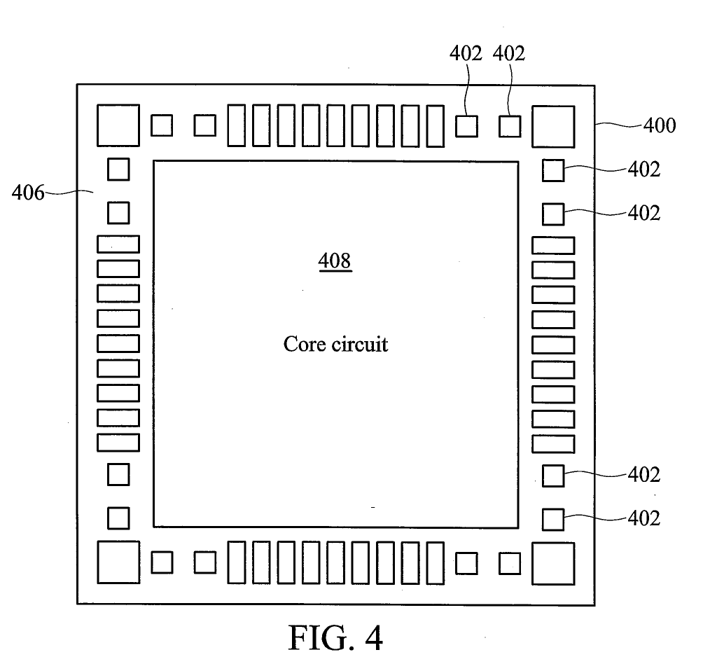

As exemplified in FIG. 4, die 400 has a core-limit design such that out-bond pads 404 and inner pads 402 as well are located in periphery 406 surrounding the core area where a core circuit 408 fully occupies, gaining the benefit of cheaper CP testing without the expense of additional die cost. In case that a die is a pad-limit design, which means the core area surrounded by out-bond pads cannot be fully filled by core circuits, inner pads can be placed in the core area while the size of the die remains the same.

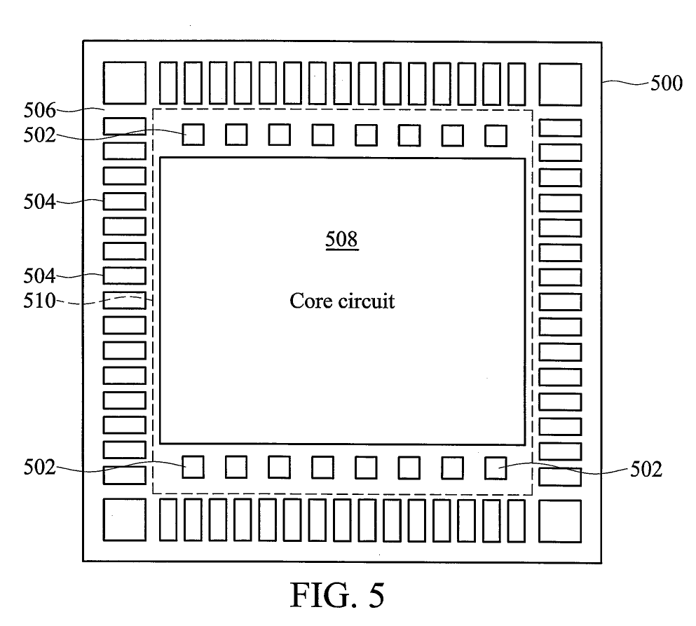

As exemplified in FIG. 5, die 500 has a pad-limit design such that the required out-bond pads 504 located in periphery 506 has determined the die size, and inner pads 502 and core circuit 508 together are located inside sparse core area 510, gaining the benefit of cheaper CP testing without the expense of additional die cost.

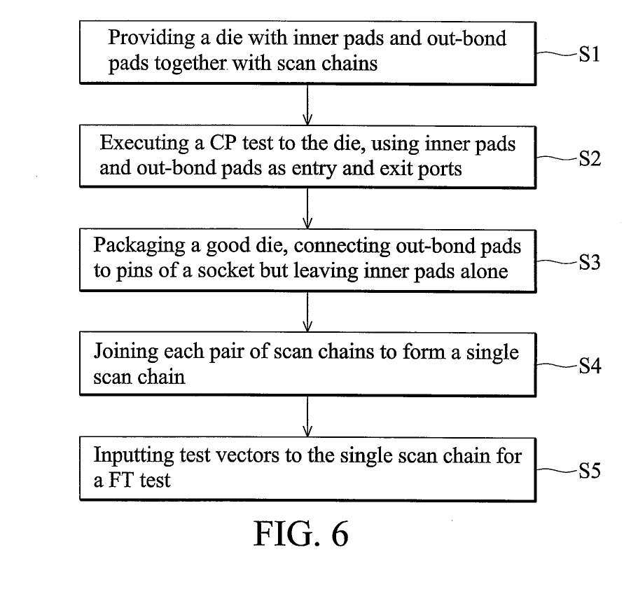

FIG. 6 is a flowchart demonstrating a method of testing circuitry according to embodiments of the invention. A wafer with die 100 of FIG. 1 is first provided (in step S1), die 100 having scan chains S₁₁˜S₁ₙ and S₂₁˜S₂ₙ, multiplexer 102 and pads IP₁₁˜IP₁ₙ, IP₂₁ ˜IP₂ₙ OP₁₁˜OP₁ₙ and OP₂₁˜OP₂ₙ, as well as the interconnection shown in FIG. 1. The wafer then undergoes CP testing (step S2), using pads IP₁₁˜IP₁ₙ, IP₂₁ ˜IP₂ₙ, OP₁₁˜OP₁ₙ and OP₂₁˜OP₂ₙ as entry and exit ports to input parallel test vectors into scan chains S₁₁˜S₁ₙ and S₂₁˜S₂ₙ and output parallel test results, as depicted in FIG. 2. During the CP testing, multiplexer 102 is properly signaled to electrically disconnect scan chains S₁₁˜S₁ₙ from scan chains S₂₁˜S₂ₙ. A die that successfully passes the CP test is to be packaged to form bonding wires connecting pads OP₁₁˜OP₁ₙ and OP₂₁˜OP₂ₙ to pins of a socket, but leave pads IP₁₁˜IP₁ₙ and IP₂₁˜IP₂ₙ disconnected from any pins of the socket (in step S3). The resulting package then undergoes a FT test. During the FT test, multiplexer 102 is properly signaled to electrically join each of scan chains S₁₁˜S₁ₙ to a corresponding scan chain S₂₁˜S₂ₙ, each pair of scan chains forming a single scan chain (in step S4). For example, scan chains S₁₁ and S₂₁ form a single scan chain with two ports connected to pad OP₁₁ and OP₂₁, and scan chains S₁₂ and S₂₂ form another single scan chain. During the FT test (in step S5), vectors, which may or may not be the vectors resulting from combining the vectors used during the CP test, are input into the single scan chains through the pins of the socket, as depicted in FIG. 3.

Inner pads, such as pads IP₁₁˜IP₁ₙ and IP₂₁˜IP₂ₙ in FIG. 3, can be electrically connected to scan chains after packaging, as long as scan chains S₁₁˜S₁ₙ separate from scan chains S₂₁˜S₂ₙ during a CP test but join scan chains S₂₁˜S₂ₙ during FT test. In an alternative embodiment, a pass gate may replace multiplexer 102 in FIG. 1, selectively connecting the right ports of scan chains S₁₁˜S₁ₙ in FIG. 1 to left ports of scan chains S₂₁˜S₂ₙ while pads IP₁₁˜IP₁ₙ are constantly connected to scan chains S₁₁˜S₁ₙ and pads IP₂₁˜IP₂ₙ to scan chains S₂₁˜S₂ₙ.

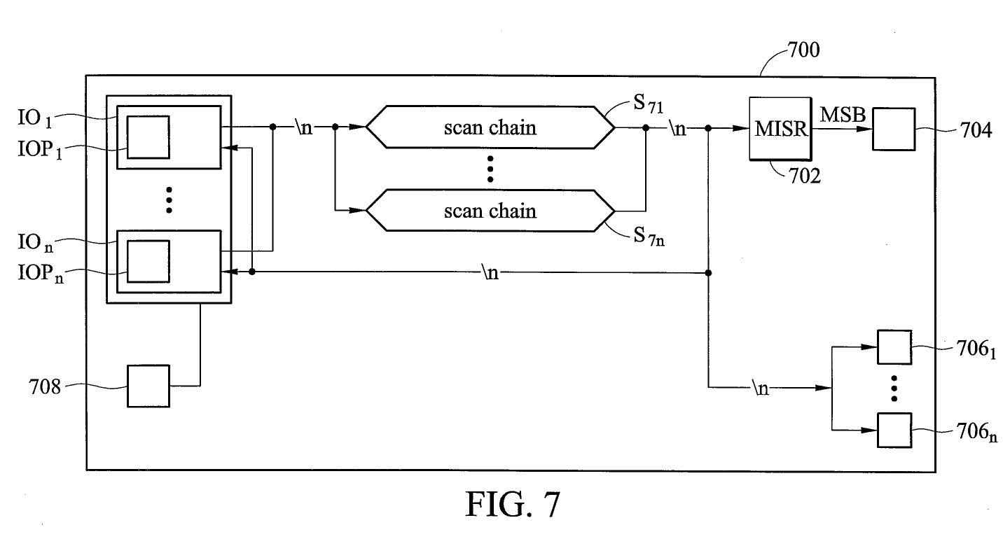

FIG. 7 illustrates die 700 with a testing configuration according to embodiments of the invention. Die 700 comprises scan chains S₇₁˜S₇ₙ, I/O circuits IO₁-IOₙ, multiple input shift register (MISR) 702, most-significant-bit (MSB) pad 704, pads 706₁˜706ₙ, and control pad 708. As shown in FIG. 7, I/O circuits IO₁˜IOₙ have pads IOP₁˜IOPₙ, respectively. Scan chains S₇₁˜S₇ₙ are of the same length, preferably. The input port of each scan chain in FIG. 7 is coupled to a corresponding I/O circuit. The output port of each scan chain is coupled not only back to the corresponding I/O circuit, but also to a corresponding pad among pads 706₁˜706ₙ, and to MISR 702 as well, which is able to compress the test results shifted out from scan chains S₇₁˜S₇ₙ and output corresponding compressed results through MSB pad 704. Whether I/O circuits IO₁˜IOₙ act as entry ports or exit ports depends upon the signal input from control pad 708. Scan chains S₇₁˜S₇ₙ may be of the same length, having the same number of D flip-flops for example.

It is well known in the art that a test result compressor, such as a MISR, can logically compare test results and reduce the output pad/pin count for scan chains. As shown in FIG. 7, MISR 702 reduces the output pad count for scan chains S₇₁˜S₇ₙ from an original number of n to one. A test result compressor may, nevertheless, confront an “X” risk or “unknown” risk, a complete solution for which can severely complex the design of the test result compressor and/or unnecessarily burden an circuit designer. In some circumstances, a circuit designer may allow a logic circuit to generate a result whose logic value cannot be assured and is not concerned. An “X” risk represents the occurrence of any of these circumstances during testing. If an “X” risk occurs, a test result compressor accordingly risks and generates an uncertain output, from which a tester cannot determine whether results from other logic circuits are correct or not since the uncertain output is a compressed output from all the results including the one whose output logic value is not assured. Die 700 in FIG. 7 provides a solution to the X risk. It is preferred that pads 706₁˜706ₙ are inner pads and provide exit ports during a CP test.

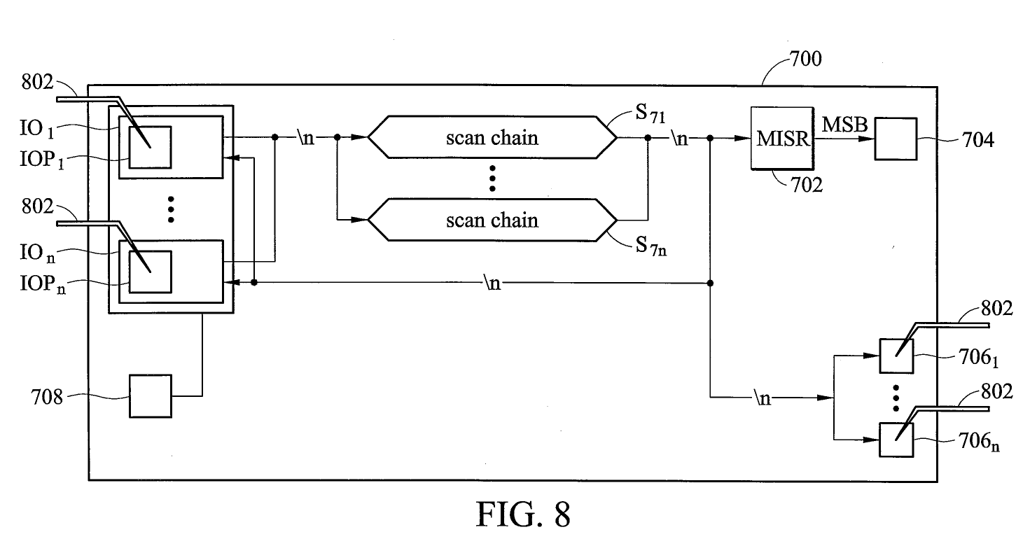

FIG. 8 illustrates die 700 of FIG. 7 during a CP test when I/O circuits IO₁-IOₙ are selected to act as entry ports for inputting test vectors to scan chains S₇₁˜S₇ₙ. As the test results from scan chains S₇₁˜S₇ₙ are individually received by probes 802 of a tester without experiencing any compression, any allowably-uncertain results can be identified and ignored while others are accurately checked. Control pad 708 and MSB pad 704 are not probed as shown in FIG. 8, but can be probed in other embodiments.

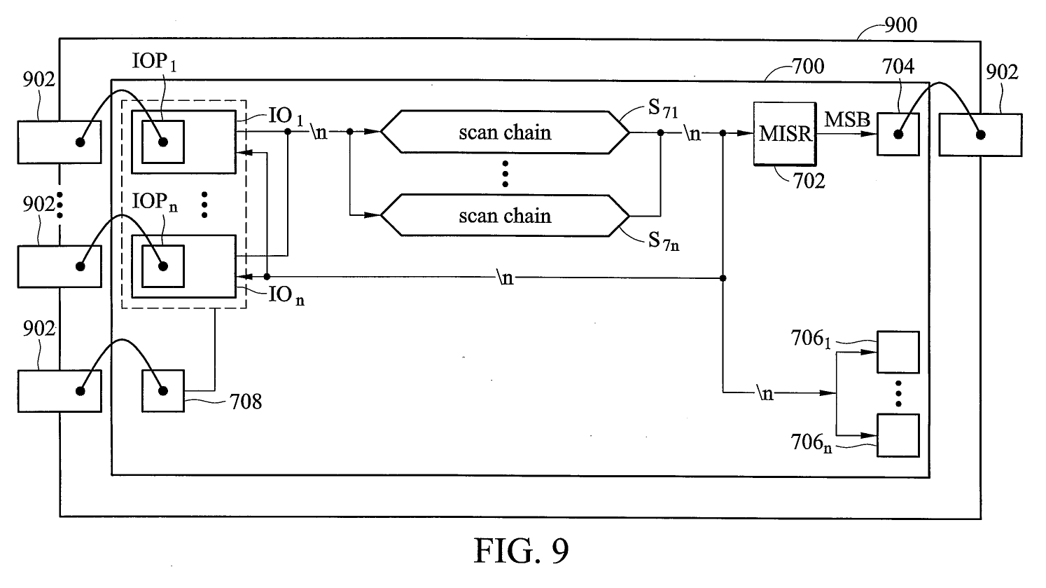

FIG. 9 illustrates die 700 of FIG. 7 during a FT test. In FIG. 9, die 700 is packaged with a socket 900 having several pins 902. Pads IOP₁˜IOPₙ, control pad 708 and MSB pad 704 are bonded to electrically connect to pins 902, but pads 706₁-706ₙ are not. Generally speaking, I/O circuits IO₁˜IOₙ mainly act as entry ports, but are temporarily switched to be exit ports when an X risk occurs.

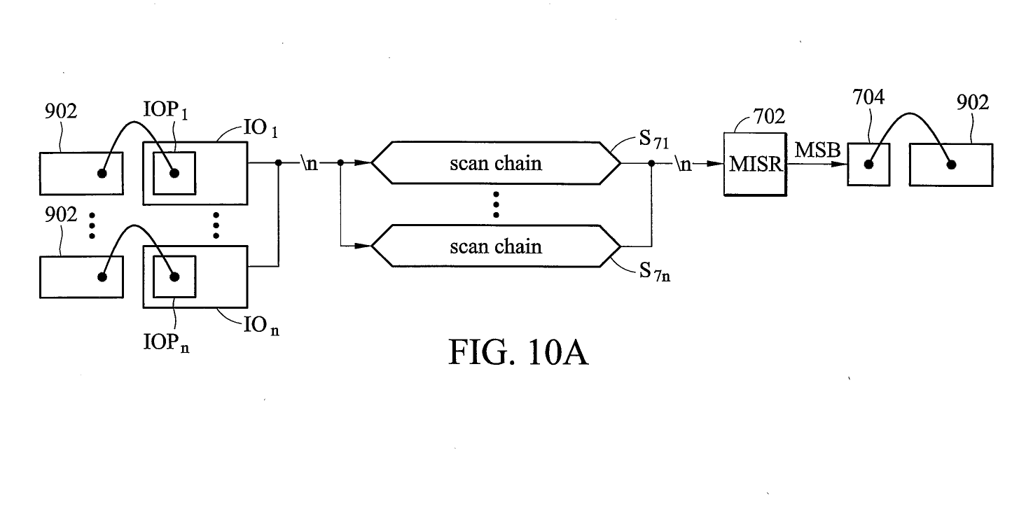

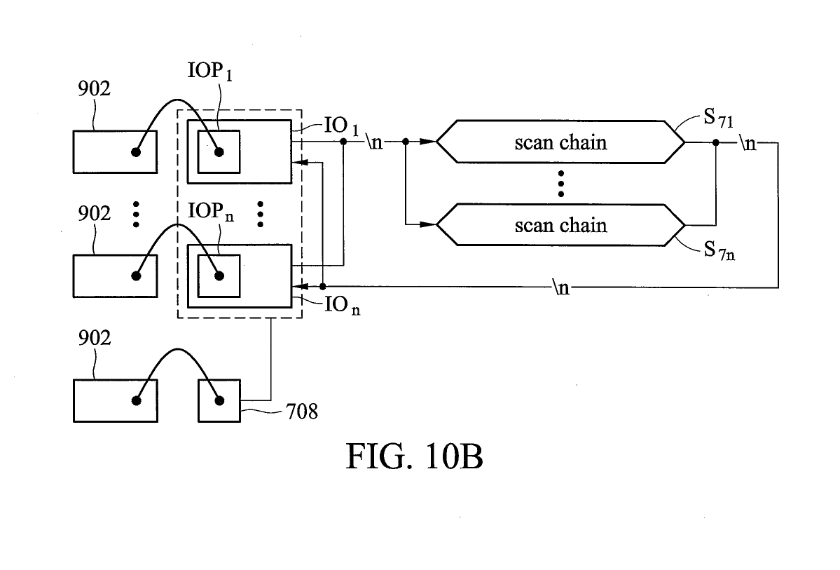

FIG. 10A illustrates the test vector and result flow for die 700 during a FT test when there is no X risk. I/O circuits IO₁˜IOₙ are entry ports and MSB pad 704 is an exit port. Most of the time during a FT test, MISR 702 compresses the test results from scan chains S₇₁˜S₇ₙ and provides compressed outputs to a tester through MSB pad 704 and a corresponding pin 902.

FIG. 10B illustrates the test vector and result flow for die 700 during a FT test when an X risk occurs. When an X risk is expected, a control signal is fed to control pad 708 to temporarily switch signal I/O circuits IO₁˜IOₙ from entry ports to exit ports, for outputting current test results, in which at least one is expected to have an allowably-uncertain value. When I/O circuits IO₁˜IOₙ act as exit ports, the output of MISR 702 (shown in FIG. 10A) may be monitored but ignored since its variation cannot guarantee any test errors. After the current test results are completely received by a tester, I/O circuits IO₁˜IOₙ are switched back to entry ports for inputting test vectors.

The test time for the CP test in FIG. 8 is proportional to the length of the longest scan chain among scan chains S₇₁˜S₇ₙ. If the length of the longest scan chain is L, the total clock number for the CP test in FIG. 8 is about #Pattern*L, where #Pattern refers to the pattern count as defined in Formula (1). If a test pattern, a group of test vectors, uses I/O circuits IO₁˜IOₙ as entry ports and MSB pad 704 as an exit port, as illustrated in FIG. 10A, the clock number for completing the testing of that test pattern should be about L. If a test pattern uses I/O circuits IO₁˜IOₙ as entry ports at one time but exit ports at another, as illustrated in FIG. 10B, the clock number for completing the testing of that test pattern is about 2L. Therefore, given the number of the test patterns each expected to render an X risk is N_{X}, the total clock number for the FT test in FIG. 9 is about (#Pattern-N_{X})*L+N_{X}*2L, which can be concluded to (#Pattern+N_{X})*L. N_{X} must be very small in view of a relatively-large pattern count since X risk rarely occurs. Thus, Nₓ can be ignored and the total clock number for the FT test is about #Pattern*L, the same as that for the CP test in FIG. 8.

The testing clock count for the CP test in FIG. 8 is reduced by way of the incorporation of pads 706₁˜706ₙ, which may or may not be inner pads. If pads 706₁˜706ₙ are inner pads, they can be of the same size as, or of a smaller size than, that of out-bond pads, such as pads IOP₁˜IOPₙ in I/O circuits IO₁˜IOₙ. Pads 706₁˜706ₙ can be inside a peripheral area or a core area depending upon whether the die is a core-limit design or a pad-limit design. Pads 706₁˜706ₙ can be pads internally connected to an embedded memory, such as an embedded DRAM or an embedded flash-ROM. Pads 706₁˜706ₙ can also be specially designed for an interface different from that supported by I/O circuits IO₁˜IOₙ in FIG. 9, or for an integrated circuit package different from that of FIG. 9.

The pin count illustrated in FIG. 9 is reduced due to the existence of MISR 702, which also causes reduction of the clock count and the testing cost during a FT test. A CP test may employ the same test configuration used in the FT test of FIG. 9, switching I/O circuits IO₁˜IOₙ based on the expectation of an X risk and requiring no pads 706₁˜706ₙ directly connected to the output ports of scan chains S₇₁˜S₇ₙ. Description of FIG. 9 also implies that a CP test using the test configuration of FIG. 9 will have the test cost substantially the same as that of the CP test in FIG. 8, while solving any X risks.

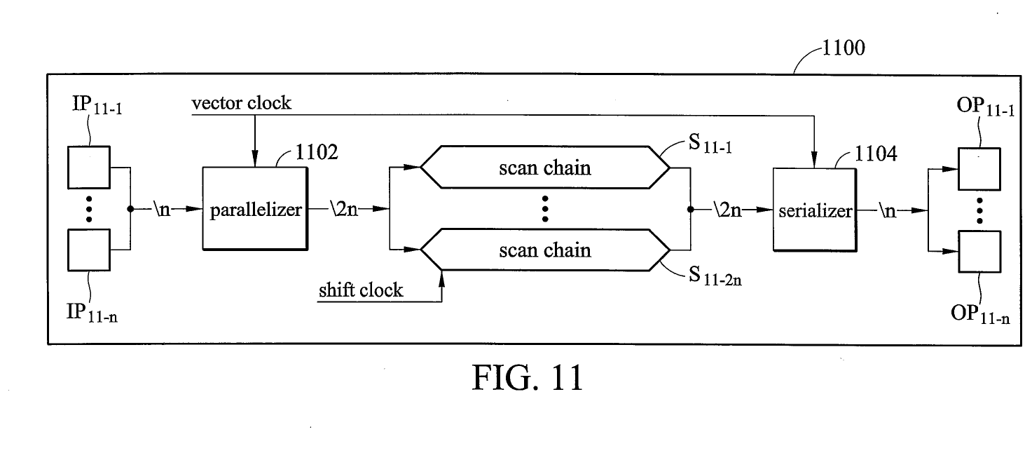

FIG. 11 illustrates an integrated circuit having a structure of scan testing. Die 1100 comprises input pads IP₁₁₋₁˜IP₁₁₋ₙ, a parallelizer 1102, scan chains S₁₁₋₁˜S₁₁₋₂ₙ, a serializer 1104, and output pads OP₁₁₋₁˜OP₁₁₋ₙ. Shift clock is provided to scan chains S₁₁₋₁˜S₁₁₋₂ₙ, which accordingly shift test vectors and test results. Parallelizer 1102 parallelizes the input data from input pads IP₁₁₋₁˜IP₁₁₋ₙ, and accordingly provides test vectors to scan chains S₁₁₋₁˜S₁₁₋₂ₙ. Serializer 1104, functionally opposite parallelizer 1102, serializes the test results from scan chains S₁₁₋₁˜S₁₁₋₂ₙ, and accordingly outputs test data to output pads OP₁₁₋₁˜OP₁₁₋ₙ. A vector clock is fed to parallelizer 1102 and serializer 1104. In FIG. 11, the number of input pads IP₁₁₋₁˜IP₁₁₋ₙ, n, is the same as that of output pads OP₁₁₋₁˜OP₁₁₋ₙ, but is half of that of scan chains S₁₁₋₁˜S₁₁₋₂ₙ, 2n. The vector clock in FIG. 11 has a higher clock frequency, double of that of the shift clock. In other words, scan chains S₁₁₋₁˜S₁₁₋₂ₙ operate under a slower frequency than parallelizer 1102, serializer 1104, input pads IP₁₁₋₁˜IP₁₁₋ₙ, and output pads OP₁₁₋₁-OP₁₁₋ₙ do.

From Formula (1), test cost, irrespective of a CP test or a FT test, is positively proportional to a clock period (T_{CP} or T_{FT} in formula (1)), inversely proportional to a shift clock frequency. In other words, increased shift clock frequency lowers test costs. The shift clock frequency cannot be unlimitedly increased, however. In respect to a conventional scan chain with a dedicated input pad and a dedicated output pad, one commonly-accepted limitation for a shift clock frequency is:

max[f(shift_clk)]<min[f(IR_drop), f(power), f(pad_speed), f(test_machine)] (3),

where f(shift_clk) is the frequency of a shift clock; f(IR_drop) is the maximum clock frequency that IR drop effect does not fail the function of the integrated circuit under test; f(power) is the maximum clock frequency under that the integrated circuit under test does not burn out or degenerate; f(pad_speed) is the maximum operating frequency allowed for input/output pads; and f(test_machine) is the maximum operating frequency of a test machine. f(test_machine) depends on the quality and capability of a tester, and can be increased by purchasing a more advanced tester. f(pad_speed) concerns the semiconductor manufacturing technology, the device size shrinkage helping the increase of the maximum operating frequency for a pad. The factors for deciding f(power) and f(IR_drop) are more complex, including the semiconductor manufacturing technology utilized in the integrated circuit and the complexity of the circuit design therein.

It is possible that an integrated circuit is designed to operate under a very high work frequency during a normal operation but a scan chain of the integrated circuit can only operate under a much slower frequency. One of the reasons may be that a CP or FT test triggers all the cells in scan chains to be simultaneously tested, but a normal operation of the integrated circuit needs only the simultaneous operation of a portion of those cells at most. As more circuits operate at the same time, the IR voltage drop, heat generated, and degeneration of the integrated circuit all increase. Furthermore, an integrated circuit may be equipped with an electric fan or heat dissipation to cool the integrated circuit while the tester for the integrated circuit may not. Thus, for example, an integrated circuit may have a specification operation clock frequency of 100 MHz, but the scan chain in the integrated circuit can only accept a much lower shift clock frequency of 50 MHz in consideration of the power consumption and the IR voltage drop. This scenario occurs more frequently in current IC products since testers and pads advance to allow a higher operating frequency but the highest frequency for a scan chain does not have a corresponding increase. According to Formula (3), the dedicated input and output pads, even possibly capable of operating at a high frequency, are forced to operate at a relatively-lower frequency limited by the scan chain.

The parallelizer 1102 and serializer 1104 in FIG. 11 break the dependence from the frequency actually applied to pads with the frequency limited by a scan chain. The limitations for the vector and shift clock frequencies respectively applied to the group of parallelizer 1102 and serializer 1104 and the group of scan chains S₁₁₋₁˜S₁₁₋₂ₙ are concluded as follows:

max[f(shift_clk)]<min[f(IR_drop), f(power)] (4)

max[f(vector_clk)]<min[f(pad_speed), f(test_machine)] (5)

Formulae (4) and (5) show the shift clock frequency still limited by the lower operating frequency of scan chains but the vector clock frequency is no more and probably approaches the higher frequency of the maximum operating frequency of pads or a test machine. Parallelizer 1102 and serializer 1104 dedicate one input pad and one output pad to serve more than one scan chain. In FIG. 11, one input pad and one output pad serve a pair of scan chains, such that the vector clock frequency is double the shift clock frequency.

The test configuration introduced in FIG. 11 is more applicable when the pin or pad count of an integrated circuit is very limited for testing. By operating at a higher frequency, parallelizer 1102 and serializer 1104 provide more effective entry and exit ports to adopt more scan chains only operable at a lower frequency while keeping the actual pin or pad count the same. As more scan chains can undergo CP or FT test, the test cost of the test configuration in FIG. 11 is less.

While the invention has been described by way of examples and in terms of preferred embodiment, it is to be understood that the invention is not limited to thereto. To the contrary, it is intended to cover various modifications and similar arrangements (as would be apparent to those skilled in the art). Thus, the scope of the appended claims should be accorded the broadest interpretation so as to encompass all such modifications and similar arrangements.

What is claimed is:

1. An integrated circuit package, comprising:
a semiconductor device, comprising:
a first scan chain and a second scan chain, each of the first and second scan chains having an input port and an output port;
at least two first pads, coupled to the input port of the first scan chain and the output port of the second scan chain, respectively;
at least two second pads, coupled to the output port of the first scan chain and the input port of the second scan chain; and
a connecting device coupled between the first and the second chains, capable of controlling electrical connection between the input port of the second scan chain and the output port of the first scan chain;
wherein when the connecting device is disabled, the input port of the second scan chain is electrically disconnected from the output port of the first scan chain; and
pins;
wherein the first pads are electrically connected to the pins and the second pads are not electrically connected to any pins.

2. The integrated circuit package of claim 1, wherein the connecting device is a multiplexer or a pass gate.

3. The integrated circuit package of claim 1, wherein the first pads are located in a peripheral area of the semiconductor device surrounding a core area of the semiconductor device, and the second pads are located in the peripheral area.

4. The integrated circuit package of claim 1, wherein the first pads are located in a peripheral area of the semiconductor device surrounding a core area of the semiconductor device, and the second pads are located in the core area.

5. The integrated circuit package of claim 1, wherein at least one of the first pads belongs to an analog input or output circuit that is capable of being configured to transport digital signal when the semiconductor device is tested in a wafer level.

6. The integrated circuit package of claim 1, further comprising an embedded memory, wherein the second pads are connected to the embedded memory.

7. The integrated circuit package of claim 6, wherein the embedded memory comprises a DRAM or a flash-ROM.

8. The integrated circuit package of claim 1, wherein the first pads are configured for a first interface and the second pads for a second interface while the first interface is different from the second interface.

9. The integrated circuit package of claim 1, wherein the first pads are configured for the integrated circuit package and the second pads for another integrated circuit package.

10. A method of testing circuitry, the method comprising:
providing a semiconductor device, comprising:
a first scan chain and a second scan chain, for testing an integrated circuit inside the semiconductor device, each of the first and second scan chains having an input port and an output port;
at least two first pads, coupled to the input port of the first scan chain and the output port of the second scan chain, respectively;
at least two second pads, coupled to the output port of the first scan chain and the input port of the second scan chain;
inputting in parallel first and second test vectors to the first and second scan chains, respectively, during a wafer level test, while electrically disconnecting the input port of the second scan chain from the output port of the first scan chain;
packaging the semiconductor device to electrically connect the first pads to pins of a socket and not electrically connect the second pads to any pins of the socket;
electrically connecting the output port of the first scan chain and the input port of the second scan chain to join the first and second scan chains into a single scan chain; and
inputting third test vectors through the pins of the socket to the single scan chain.

11. A semiconductor device with a testing configuration, comprising:
scan chains, each scan chain having input ports and output ports;
I/O circuits, each having a first pad, configured to send test vectors in one condition to the input ports of the scan chains, and to receive test results in another condition from the output ports of the scan chains; and
a test result compressor, coupled to the output ports of the scan chains, for compressing the test results to output corresponding compressed results through a result pad.

12. The semiconductor device of claim 11, further comprising second pads, each connected to a corresponding output port of the scan chains.

13. The semiconductor device of claim 12, wherein the first pads are located in a peripheral area of the semiconductor device surrounding a core area of the semiconductor device, and the second pads are located in the peripheral area.

14. The semiconductor device of claim 12, wherein the first pads are located in a peripheral area of the semiconductor device surrounding a core area of the semiconductor device, and the second pads are located in the core area.

15. An integrated circuit package, comprising:
the semiconductor device of claim 12; and
a socket comprising:
first pins connected to the first pads of the I/O circuits; and
a compressed result pin connected to the result pad;
wherein the second pads are not electrically connected to any pins of the socket.

16. The integrated circuit package of claim 15, further comprising an embedded memory, wherein the second pads are internally connected to the embedded memory.

17. The integrated circuit package of claim 15, wherein the embedded memory comprises a DRAM or a flash-ROM.

18. The integrated circuit package of claim 15, wherein the first pads are configured for a first interface and the second pads for a second interface and the first interface is different from the second interface.

19. The integrated circuit package of claim 15, wherein the first pads are configured for the integrated circuit package and the second pads for another integrated circuit package.

20. A method of testing circuitry on a semiconductor device, the method comprising:
providing the semiconductor device of claim 11;
setting the I/O circuits in the one condition and inputting the test vectors to the scan chains through the first pads;
enabling the test result compressor to compress the test results and verifying the corresponding compressed results from the result pad; and
setting the I/O circuits in the another condition and verifying the test results through the first pads.

21. An integrated circuit having a structure of scan testing, comprising:
an input pad and an output pad;
scan chains for receiving test vectors and outputting test results based on a shift clock;
a parallel circuit for parallelizing input data from the input pad to accordingly provide the test vectors to the scan chains; and
a serial circuit for serializing the test results to output test data to the output pad;
wherein the parallel circuit and serial circuit operate based on a test vector clock having a frequency higher that the shift clock.
